(19) United States
(12) Patent Application Publication
(10) Pub. No.: US 2021/0270212 A1
(43) Pub. Date: Sep. 2, 2021

(54) TANK VENTILATION

(71) Applicant: Polytec Plastics Germany GmbH & Co. KG, Leiden (DE)

(72) Inventors: Hans Janssen, Dinklage (DE); Jorge Soares, Wettringen (DE); Christian Berding, Lohne (DE)

(21) Appl. No.: 17/255,184

(22) PCT Filed: May 31, 2019
(86) PCT No.: PCT/EP2019/064204

§ 371 Date: Dec. 22, 2020

(30) Foreign Application Priority Data
Aug. 24, 2018 (DE) 20 2018 104 879.1

(51) Int. Cl. F02M 25/08; F02M 35/10; F02M 25/06; F01M 13/02; F04F 5/22; F04F 5/54

(52) U.S. Cl. CPC F02M 25/08; F02M 35/10222; F02M 25/06; F01M 2013/026; F01M 13/021; F04F 5/22; F04F 5/54; F02M 35/10229

(57) ABSTRACT

The invention relates to an internal combustion engine comprising a turbocharger between an air filter and a crankcase, a fuel tank, and a ventilation arrangement for the fuel tank, comprising a jet suction pump.

### CROSS-REFERENCE TO RELATED APPLICATION(S)

This application is a U.S. National Stage Entry Under 35 U.S.C. 371 of International Application No. PCT/EP2019/064204 filed on May 31, 2019, which claims priority to German Patent Application No. 20 2018 104 879.1 filed on Aug. 24, 2018, the contents of which are incorporated herein by reference in their entirety.

### FIELD OF THE INVENTION

The present invention relates to an internal combustion engine comprising a turbocharger between an air filter and a crankcase, a fuel tank and a ventilation device for the fuel tank, comprising a jet suction pump.

### BACKGROUND OF THE INVENTION

In order to reduce the negative pressure in the engine or to compensate for the pressure rise caused by an oil separator, active pumps for internal combustion engines are employed that actively aspirate blow-by gases, for example, by vacuum pumps or impeller pumps.

In the tank of a motor vehicle with a gasoline engine, volatile hydrocarbons will evaporate, depending on the pressure, the temperature and the composition and the vapor pressure of the fuel.

To keep such hydrocarbons from getting into the atmosphere, they are supplied to the engine, especially the crankcase, for combustion. This is effected either directly through a shortcut line, or with interim storage in an active charcoal filter. In such a filter, the hydrocarbons are absorbed completely. The active charcoal filters are regenerated by utilizing the negative pressure prevailing in the suction pipe for aspirating the hydrocarbons from the active charcoal container.

For this purpose, part of the combustion air is aspirated by negative pressure through the active charcoal filter. A kind of preliminary control is effected by the active charcoal filter pulse valve. The recirculated amounts are mostly on the order of 2% of the aspirated amount of air. In most common engines, the recirculation can be effected throughout the operational range, from idle to full load.

The housing of the filters is usually made of sheet steel or plastic. The air is passed through a non-woven or a similar material in order to avoid soil depositions at the charcoal packing.

DE 10 2015 200 341.8 describes a jet suction pump for ventilating an internal combustion engine comprising a turbocharger between an air filter and a crankcase, characterized in that a charge air duct has a branch to an at least two-stage jet suction pump, wherein the inlet of said jet suction pump is connected with the crankcase through the engine ventilation system, and the outlet of said jet suction pump is connected with the suction duct between the air filter and the turbocharger for recirculating blow-by gas.

### BRIEF SUMMARY OF THE INVENTION

It is the object of the present invention to produce a negative pressure in a motor vehicle tank, more specifically in an active charcoal filter of a motor vehicle tank, by connecting a jet suction pump for tank ventilation, and to supply the fuel contained therein to combustion, and optionally to simultaneously provide a negative pressure in a crankcase as well.

According to an embodiment, disclosed is an internal combustion engine with a turbocharger between an air filter and a crankcase, a motor vehicle tank, and a ventilation system for the fuel tank, comprising a jet suction pump, wherein the ventilation system has a charge air duct with a branch to the jet suction pump. The inlet of the jet suction pump is connected with the fuel tank through the ventilation system, and the outlet of said jet suction pump is connected with the suction duct between the air filter and the turbocharger. A propulsion jet coming from said charge air duct is pressed through a first nozzle, and the jet entrains gas at its circumference, and after the first stage, the volume flow, which was increased by the added air, subsequently flows through a second nozzle having a larger air cross section and a third nozzle having an even larger air cross section, a portion of the gas again being entrained.

### BRIEF DESCRIPTION OF THE DRAWINGS

The present invention is illustrated and described herein with reference to the drawings, in which any like reference numbers denote like method steps and/or system components, respectively, and in which:

FIG. 1 illustrates features of an internal combustion engine, according to embodiments of the invention.

FIG. 2 illustrations further features of an internal combustion engine, according to embodiments of the invention, wherein the crankcase 4 is connected in parallel with the jet suction pump 9 through the duct 11 as a ventilation device.

FIG. 3 illustrates further features of an internal combustion engine, according to embodiments of the invention, wherein the jet suction pump has three different nozzle stages.

### DETAILED DESCRIPTION OF THE INVENTION

According to embodiments of the invention, the above object is achieved in a first embodiment by a an internal combustion engine with a turbocharger 3 between an air filter 1 and a crankcase 4, a motor vehicle tank 10, and a ventilation system 6, especially an active charcoal filter for the fuel tank 10, comprising a jet suction pump 7, wherein said ventilation system 6 has a charge air duct 5 with a branch to the jet suction pump 7, characterized in that the inlet of said jet suction pump 7 is connected with the fuel tank 10 through the ventilation system 6, and the outlet of said jet suction pump 7 is connected with the suction duct 9 between the air filter 1 and the turbocharger 3, wherein a propulsion jet coming from said charge air duct 5 is pressed through a first nozzle, and the jet entrains gas at its circumference, and after the first stage, the volume flow, which was increased by the added air, subsequently flows through a second nozzle having a larger air cross section and a third nozzle having an even larger air cross section, a portion of the gas again being entrained.

According to embodiments of the invention, the jet suction pump 7 is provided as an independent component, but may also be identical with the one described in DE 10 2015 200 341.8, and thus at the same time serve for the ventilation of the tank 10 and for the ventilation of the crankcase 4.

Multi-stage jet suction pumps 7 are particularly suitable for the present purpose, because the absence of moving parts leads one to expect a wear-free pump 7. As compared to a one-stage jet suction pump, a multi-stage jet suction pump 7 shows a clearly improved efficiency, i.e., a better ratio of suction to propulsion flows, so that in a three-stage jet suction pump, for example, the propulsion flow can be half of that used in a one-stage jet suction pump, with the same delivery capacity.

The multi-stage pump 7 employed according to embodiments of the invention acts by pressing a propulsion jet (e.g., pressurized air from the charged suction tube) through a small nozzle, so that the jet entrains gas at its circumference, and after the first stage, the volume flow increased by the supply air is subsequently flowed through a second nozzle having a larger air cross section and a third nozzle having an even larger air cross section, a portion of the gas again being entrained. After the first stage, the volume flow increased by the supply air is subsequently flowed through a second, larger, nozzle and a third, even larger, nozzle, wherein a portion of gas is again entrained.

At each nozzle, the propulsion jet entrains a fraction of the gas to be conveyed (tank ventilation and, if present, blow-by gas). Because of the multi-stage property, the volume flow conveyed becomes significantly larger (a factor of 2, 3 or more) as with a one-stage jet suction pump. The more stages, the better.

Because of this improved efficiency, the conveyed volume flow as well as the pressure increase produced by the propulsion jet can be improved.

A basic disadvantage of the jet suction pump 7 is the fact that it also produces a pressure loss in a forced flow mode. The multi-stage property produces a sharply adjusted pump 7 that has no propulsion jet in a case where the internal combustion engine works in non-charged operation, and thus only serves for ventilating the tank 6.

In non-charged operation, the gas from the tank ventilation and the blow-by gas, if any, would have to be pressed through the small nozzles, producing a pressure loss that is of no importance here. For an optimally constructed multi-stage jet suction pump 7, this pressure loss is significant (5 to 100 mbar depending on the volume flow). Since this drawback may exceed the benefit of the jet suction pump 7, at least one bypass valve 8 and/or one check valve 8, respectively, is provided for tank ventilation and optionally for the crankcase 4 for this application in a preferred embodiment according to the invention, which in a case where the jet suction pump 7 does not produce a propulsion jet, directs the tank ventilation gas and the blow-by gas, if any, past the pump 7, and thus minimizes the pressure loss for this case.

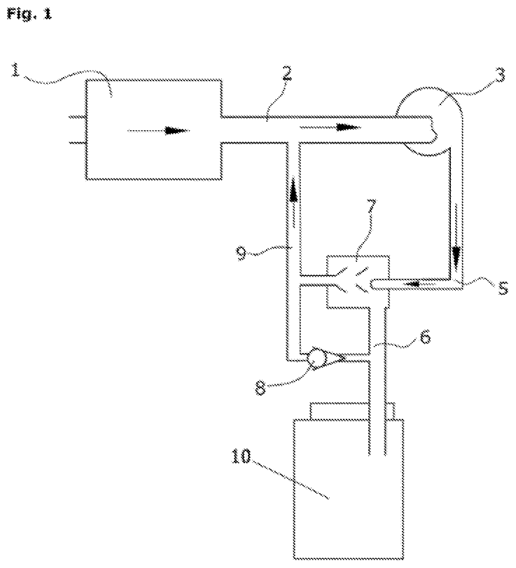

FIG. 1 shows a preferred embodiment of the present invention. Starting from an air filter 1, the tank ventilation gas is supplied to the multi-stage jet suction pump 7 through the turbocharger 3 and the charge air duct 5. In the embodiment that is particularly preferred here, another branch of the tank ventilation leads to a bypass valve 8 and/or a check valve 8 that recirculates the gas flow through the gas recirculation duct 9 to the suction duct 2 between the air filter 1 and turbocharger 3 when there is a weak or non-existent propulsion jet in the jet suction pump 7.

When the engine works in turbocharging operation, the valve 8 is closed because of the higher pressure downstream the jet suction pump 7. When the engine works in non-charged operation, the tank ventilation gas and the blow-by gas, if any, can flow past the pump 7 without a pressure loss. Thus, this operation mode is optimized by a combination of the jet suction pump 7 with the bypass valve 8 and/or the check valve 8.

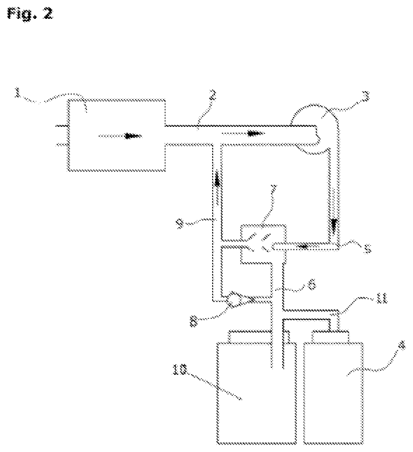

In a preferred embodiment in FIG. 2, the crankcase 4 is connected in parallel with the jet suction pump 7 through the duct 11 as a ventilation device. Here, the crankcase ventilation is another parallel or optionally serial connection between the crankcase 4 and the jet suction pump 7.

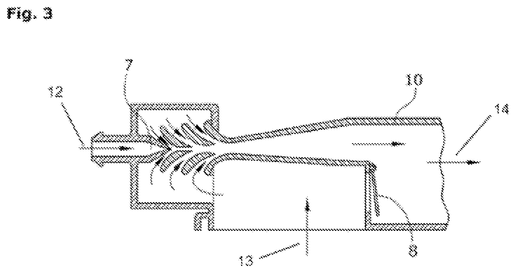

FIG. 3 shows another preferred embodiment of the present invention in which the jet suction pump 7 has three different nozzle stages. However, a higher number of nozzles, for example, 4, 5 or 6 with a respectively increasing nozzle cross section, is particularly preferred according to the invention, wherein a propulsion jet coming from said charge air duct 5 is pressed through a first nozzle, and the jet entrains gas at its circumference, and after the first stage, the volume flow, which was increased by the added air, subsequently flows through a second nozzle having a larger air cross section and a third nozzle having an even larger air cross section, a portion of the gas again being entrained.

The pump 7 is preferably made of plastic, for example, polyamide. Parts of the pump may also be realized within the cylinder head cover.

Alternatively, the complete component may also prepared as a module consisting of the jet suction pump 7 with the bypass valve 8 and/or the check valve 8 with hose connectors.

1. An internal combustion engine with a turbocharger between an air filter and a crankcase, a motor vehicle tank, and a ventilation system for the fuel tank, comprising a jet suction pump, wherein said ventilation system has a charge air duct with a branch to the jet suction pump, wherein the inlet of said jet suction pump is connected with the fuel tank through the ventilation system, and the outlet of said jet suction pump is connected with the suction duct between the air filter and the turbocharger, wherein a propulsion jet coming from said charge air duct is pressed through a first nozzle, and the jet entrains gas at its circumference, and after the first stage, the volume flow, which was increased by the added air, subsequently flows through a second nozzle having a larger air cross section and a third nozzle having an even larger air cross section, a portion of the gas again being entrained.

2. The internal combustion engine according to claim 1, wherein said jet suction pump has at least 4 stages.

3. The internal combustion engine according to claim 1, wherein said jet suction pump is integrated into a cylinder head cover of a motor vehicle.

4. The internal combustion engine according to claim 1, wherein said jet suction pump is made of plastic.

5. The internal combustion engine according to claim 1, wherein said ventilation system has at least one bypass valve and/or one check valve in flow direction in parallel with the jet suction pump and between the fuel tank and the crankcase.

6. The internal combustion engine according to claim 1, wherein the inlet of said jet suction pump is additionally connected with the crankcase through a second ventilation system.

7. A method of using the jet suction pump in the internal combustion engine according to claim 1 for ventilating the fuel tank in the internal combustion engine.

8. The method of using the jet suction pump according to claim 7 for simultaneously ventilating the crankcase.

9. The internal combustion engine according to claim 2, wherein the jet suction pump has 5 stages.

10. The internal combustion engine according to claim 2, wherein the jet suction pump has 6 or more stages.

11. The internal combustion engine according to claim 2, wherein the jet suction pump is integrated into a cylinder head cover of a motor vehicle.

12. The internal combustion engine according to claim 2, wherein said ventilation system has at least one bypass valve and/or one check valve in flow direction in parallel with the jet suction pump and between the fuel tank and the crankcase.

13. The internal combustion engine according to claim 3, wherein said ventilation system has at least one bypass valve and/or one check valve in flow direction in parallel with the jet suction pump and between the fuel tank and the crankcase.

14. The internal combustion engine according to claim 4, wherein said ventilation system has at least one bypass valve and/or one check valve in flow direction in parallel with the jet suction pump and between the fuel tank and the crankcase.

15. The internal combustion engine according to claim 4, wherein said jet suction pump is made of polyamide.

16. The internal combustion engine according to claim 2, wherein the inlet of said jet suction pump is additionally connected with the crankcase through a second ventilation system.

17. The internal combustion engine according to claim 3, wherein the inlet of said jet suction pump is additionally connected with the crankcase through a second ventilation system.

18. The internal combustion engine according to claim 4, wherein the inlet of said jet suction pump is additionally connected with the crankcase through a second ventilation system.

19. The internal combustion engine according to claim 5, wherein the inlet of said jet suction pump is additionally connected with the crankcase through a second ventilation system.
